(19) United States
(12) Patent Application Publication
(10) Pub. No.: US 2025/0252448 A1
(43) Pub. Date: Aug. 7, 2025

(54) METHOD AND SYSTEM FOR VIRTUALLY TETHERING A PHYSICAL PRODUCT TO AN AUTHENTICATED PHYSICAL RECORD

(71) Applicant: JPMorgan Chase Bank, N.A., New York, NY (US)

(72) Inventors: Andres MUNOZ GARZA, Madrid (ES); Annita VAPSI, New York, NY (US); Nancy THOMAS, New York, NY (US); Daniel BORRAJO, Pozuelo de Alarcon (ES)

(73) Assignee: JPMorgan Chase Bank, N.A., New York, NY (US)

(21) Appl. No.: 18/429,927

(22) Filed: Feb. 1, 2024

(51) Int. Cl. G06Q 30/018

(52) U.S. Cl. CPC G06Q 30/018

(57) ABSTRACT

A system for implementing a tool that virtually tethers a product to an authenticated physical record of the product. The system comprises a processor and memory that stores instructions that, when executed by a processor, cause the processor to perform operations. The operations may comprise: receiving a set of images of a first product; processing the set of images to determine a first set of attributes of the first product; determining whether the authenticated physical record comprises a description of the first set of attributes; and when a determination is made that the authenticated physical record comprises the description of the first set of attributes, utilizing the tool to virtually tether the first product to the authenticated physical record.

### BACKGROUND

### 1. Field of the Invention

The field of the invention disclosed herein generally relates to a virtual tethering and authentication tool and, more particularly, to a method, system, and computer-readable storage medium for implementing technology that virtually tethers a product to an authenticated physical record, thereby improving the veracity, speed, accuracy, efficiency, and ease of use of existing product authentication technology.

### 2. Background of the Invention

There is currently no reliable technology available for virtually tethering a product to an authenticated record.

Retrieving an image of a corresponding product (such as a vehicle, for example) poses unique challenges not only because existing products are always being updated, but also because new products are always being launched and foreign products are always being imported. However, conventional classifiers cannot reliably classify examples that they have never seen before. In addition, it is insufficient for a classifier to simply assign a simple label to a product. Another challenge of product image retrieval is that the available public datasets of such images, do not include all the characteristics, features or attributes of a product.

Therefore, there is a need in the field of the herein-disclosed invention for a technical solution to the foregoing limitation(s) in the technology of existing approaches for processing images.

### SUMMARY

The present disclosure, through one or more of its various aspects, embodiments, and/or specific features or sub-component, provides, inter alia, various systems, servers, devices, methods, media, programs and platforms for implementing a virtual tethering and authentication tool that virtually tethers a product to an authenticated physical record and provides a dynamically customizable interface for managing such tethers.

According to an aspect of the present disclosure, a method is provided for implementing a tool that virtually tethers a product to an authenticated physical record of the product. The may method comprise: receiving a set of images of a first product; processing the set of images to determine a first set of attributes of the first product; determining whether the authenticated physical record comprises a description of the first set of attributes; and when a determination is made that the authenticated physical record comprises the description of the first set of attributes, utilizing the tool to virtually tether the first product to the authenticated physical record. The set of images may comprise at least one complete view of the first product, the first product may occupy a majority of a visible region of the at least one complete view, and at least one view from among the at least one complete view may further capture an authenticatable identification of the first product.

In the method, the first set of attributes may comprise at least one from among: a first product type, a first product color, a first product model, a first product manufacturer, and a first product year of manufacture.

In the method, the first product may comprise a vehicle and the authenticatable identification may comprise a license plate.

In the method, the processing may comprise determining a predetermined number of product features that fall within a similarity threshold of at least one feature of the first product by comparing the first set of images to a reference data repository of the product features.

In the method, the processing may comprise determining a first product color and a first product model.

In the method, the determining the first product color and the first product model may comprise utilizing, to perform the processing, an artificial intelligence and machine learning (AI/ML) model that evaluates the set of images.

In the method, the AI/ML model may comprise a first AI/ML model that is trained to determine the first product color and a second AI/ML model that is trained to determine the first product model.

The method may further comprise rejecting at least one incomplete view of the first product when the at least one incomplete view is received.

The method may further comprise generating the at least one complete view by cropping a second image. The first product may occupy less than a majority of the visible region of the second image.

In the method, each image included in the set of images may be captured by at least one camera.

According to another aspect of the present disclosure, a system is provided for implementing a tool that virtually tethers a product to an authenticated physical record of the product. The system may comprise a processor and memory storing instructions that, when executed by the processor, cause the processor to perform operations. The operations may include: receiving a set of images of a first product; processing the set of images to determine a first set of attributes of the first product; determining whether the authenticated physical record comprises a description of the first set of attributes; and when a determination is made that the authenticated physical record comprises the description of the first set of attributes, utilizing the tool to virtually tether the first product to the authenticated physical record. The set of images may comprise at least one complete view of the first product, the first product may occupy a majority of a visible region of the at least one complete view, and at least one view from among the at least one complete view may further capture an authenticatable identification of the first product.

In the system, when executed by the processor, the instructions may cause the first set of attributes to comprise at least one from among: a first product type, a first product color, a first product model, a first product manufacturer, and a first product year of manufacture.

In the system, the first product may comprise a vehicle, and the authenticatable identification may comprise a license plate.

In the system, when executed by the processor, the instructions may cause the processing to comprise determining a predetermined number of product features that fall within a similarity threshold of at least one feature of the first product by comparing the first set of images to a reference data repository of the product features.

In the system, when executed by the processor, the instructions may cause the processing to comprise determining a first product color and a first product model.

In the system, when executed by the processor, the instructions may cause the determining the first product color and the first product model to comprise utilizing, to perform the processing, an artificial intelligence and machine learning (AI/ML) model that evaluates the set of images.

In the system, when executed by the processor, the instructions may cause the AI/ML model to comprise a first AI/ML model that is trained to determine the first product color and a second AI/ML model that is trained to determine the first product model.

In the system, when executed, the instructions may cause the processor to perform further operations that include rejecting at least one incomplete view of the first product when the at least one incomplete view is received.

In the system, when executed, the instructions may cause the processor to perform further operations that include generating the at least one complete view by cropping a second image. The first product may occupy less than a majority of the visible region of the second image.

In the system, each image included in the set of images may be captured by at least one camera.

According to yet another aspect of the present invention, a non-transitory computer-readable medium is provided for implementing a tool that virtually tethers a product to an authenticated physical record of the product. The computer-readable medium stores instructions that, when executed by a processor, causes the processor to perform operations. The operations may include: receiving a set of images of a first product; processing the set of images to determine a first set of attributes of the first product; determining whether the authenticated physical record comprises a description of the first set of attributes; and when a determination is made that the authenticated physical record comprises the description of the first set of attributes, utilizing the tool to virtually tether the first product to the authenticated physical record. The set of images may comprise at least one complete view of the first product, the first product may occupy a majority of a visible region of the at least one complete view, and at least one view from among the at least one complete view may further capture an authenticatable identification of the first product.

In the computer-readable medium, when executed by the processor, the instructions may cause the first set of attributes to comprise at least one from among: a first product type, a first product color, a first product model, a first product manufacturer, and a first product year of manufacture.

In the computer-readable medium, the first product may comprise a vehicle and the authenticatable identification may comprise a license plate.

In the computer-readable medium, when executed by the processor, the instructions may cause the processing to comprise determining a predetermined number of product features that fall within a similarity threshold of at least one feature of the first product by comparing the first set of images to a reference data repository of the product features.

In the computer-readable medium, when executed by the processor, the instructions may cause the processing to comprise determining a first product color and a first product model.

In the computer-readable medium, when executed by the processor, the instructions may cause the determining the first product color and the first product model to comprise utilizing, to perform the processing, an artificial intelligence and machine learning (AI/ML) model that evaluates the set of images.

In the computer-readable medium, when executed by the processor, the instructions may cause the AI/ML model to comprise a first AI/ML model that is trained to determine the first product color and a second AI/ML model that is trained to determine the first product model.

The computer-readable medium, when executed, the instructions may cause the processor to perform further operations that include rejecting at least one incomplete view of the first product when the at least one incomplete view is received.

The computer-readable medium, when executed, the instructions may cause the processor to perform further operations that include generating the at least one complete view by cropping a second image, wherein the first product occupies less than a majority of the visible region of the second image.

In the computer-readable medium, each image included in the set of images may be captured by at least one camera.

Thereby, the invention disclosed herein improves the veracity, speed, accuracy, efficiency, and ease of use of existing product authentication technology by providing a system for creating and managing and least one virtual tether via one or more dynamically customizable interface.

The present disclosure, through one or more of its various aspects, embodiments, and/or specific features or sub-component, provides, inter alia, various systems, servers, devices, methods, media, programs and platforms for virtually tethering a product to an authenticated physical record, thereby improving the veracity, speed, accuracy, efficiency, and ease of use of existing product authentication technology.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 depicts a diagram of an exemplary computer system.

FIG. 2 depicts a diagram of an exemplary network environment for virtually tethering a product to an authenticated record.

FIG. 3 depicts a diagram of an exemplary perspective of a network environment for virtually tethering a product to an authenticated record.

FIG. 4 depicts a flowchart of an exemplary process for virtually tethering a product to an authenticated record.

FIG. 5 depicts a flowchart of an exemplary process for virtually tethering a product to an authenticated record.

FIG. 6 depicts a flowchart of an exemplary aspect of a process for virtually tethering a product to an authenticated record.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

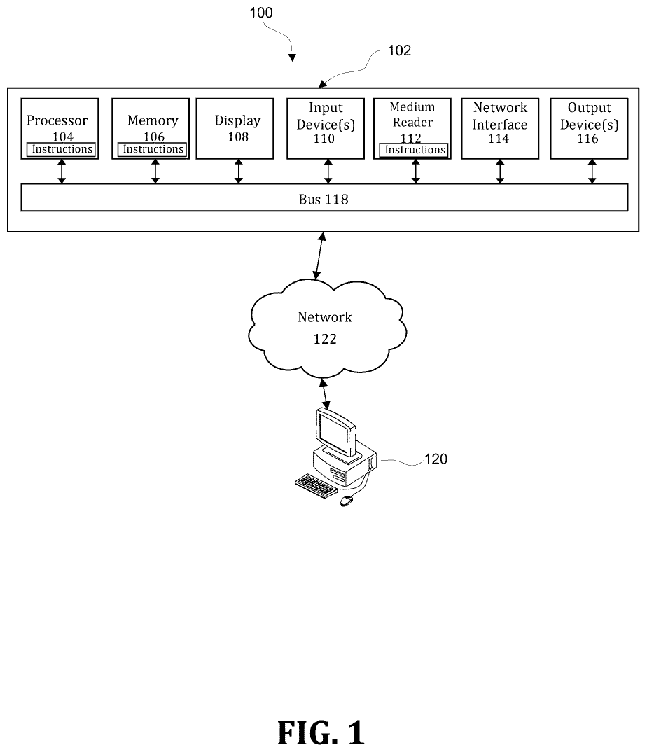

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a virtual tethering and authentication tool that virtually tethers a product to an authenticated physical record and provides a dynamically customizable interface for managing such tethers.

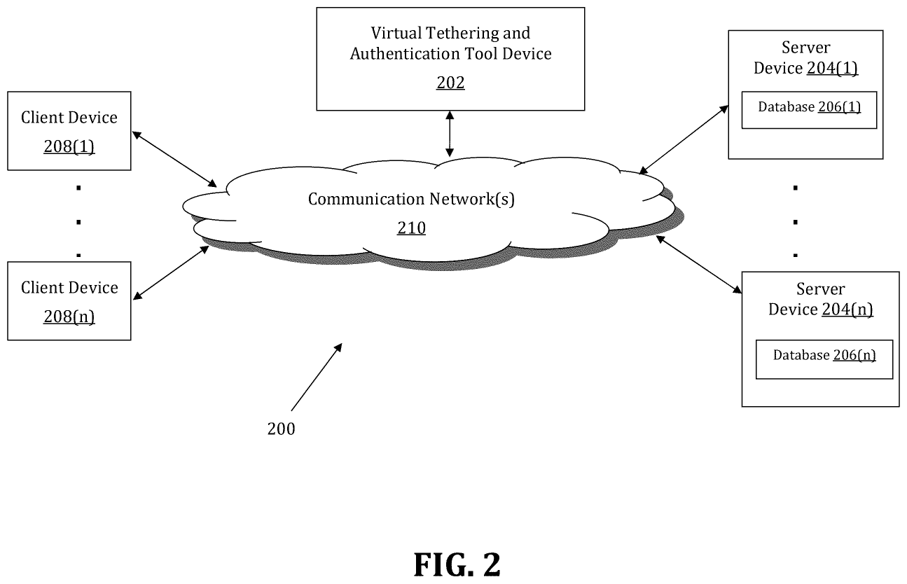

Referring to FIG. 2, a schematic of an exemplary network environment 200 for implementing a tool that virtually tethers a product to an authenticated physical record. In an exemplary embodiment, a virtual tethering and authentication tool may be implemented on any networked computer platform, such as, for example, a personal computer (PC).

A method for implementing a tool that virtually tethers a product to an authenticated physical record may be implemented by a Virtual Tethering and Authentication Tool (VTAT) device 202. The VTAT device 202 may be the same or similar to the computer system 102 as described with respect to FIG. 1. The VTAT device 202 may be a rack-mounted server in a datacenter, an embedded microcontroller (MCU) in an electronic device, or another type of headless system, which is a computer system or device that is configured to operate without a monitor, keyboard and mouse. The VTAT device 202 may store one or more applications that can include executable instructions that, when executed by the VTAT device 202, cause the VTAT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the VTAT device 202 itself, may be located in virtual server(s) running in a cloud-based computing environment rather than being tied to one or more specific physical network computing devices. Also, the application(s) may be running in one or more virtual machines (VMs) executing on the VTAT device 202. Additionally, in one or more embodiments of this technology, virtual machine(s) running on the VTAT device 202 may be managed or supervised by a hypervisor.

In the network environment 200 of FIG. 2, the VTAT device 202 is coupled to a plurality of server devices 204(1)-204(n) that hosts a plurality of databases 206(1)-206(n), and also to a plurality of client devices 208(1)-208(n) via communication network(s) 210. A communication interface of the VTAT device 202, such as the network interface 114 of the computer system 102 of FIG. 1, operatively couples and communicates between the VTAT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VTAT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and VTAT devices that implement a method for a virtual tethering and authentication tool that improves the veracity, speed, accuracy, efficiency, and ease of use of existing product authentication technology.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The VTAT device 202 may be a standalone device or integrated with one or more other devices or apparatuses, such as one or more of the server devices 204(1)-204(n), for example. In one particular example, the VTAT device 202 may include or be hosted by one of the server devices 204(1)-204(n), and other arrangements are also possible. As another example, the VTAT device 202 may be integrated with one or more other devices or apparatuses, such as one or more of the client devices 208(1)-208(n). Moreover, one or more of the devices of the VTAT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the VTAT device 202 via the communication network(s) 210 according to an HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the VTAT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the VTAT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the VTAT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VTAT device 202, the server devices 204(1)-204(n), the databases 206(1)-206(n), or the client devices 208(1)-208(n), for example, may be configured to operate as virtual instances on the same physical machine. In other words, one or more of the VTAT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

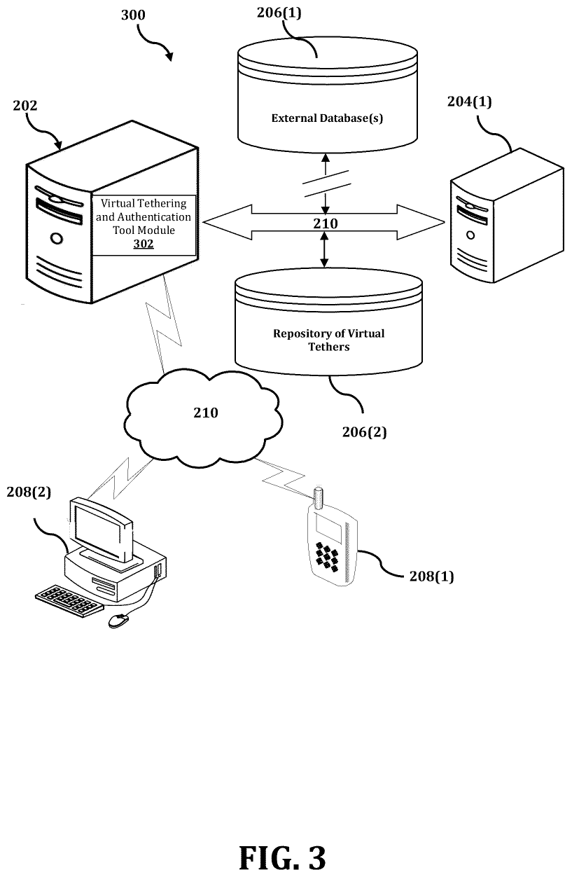

The VTAT device 202 is described and illustrated in FIG. 3 as including virtual tethering and authentication tool module 302, although it may include other rules, policies, modules, databases, or applications, for example. As will be described below, virtual tethering and authentication tool module 302 is configured to provide a dynamically customizable interface for fine-grained management of one or more database migrations and thereby improve the veracity, speed, accuracy, efficiency, and ease of use of existing product authentication technology. Virtual tethering and authentication tool module 302 may include software that is based on a microservices architecture.

Virtual tethering and authentication tool module 302 may be integrated with one or more devices or apparatuses, such as client devices 208(1)-208(n), where virtual tethering and authentication tool module 302 may be implemented as an application or as an addon or plugin to another application of the one or more devices or apparatuses, and where virtual tethering and authentication tool module 302 may execute in the background.

An exemplary process 300 for application of a virtual tethering and authentication tool to an aspect of the network environment of FIG. 2 is illustrated as being executed in FIG. 3. Specifically, a first client device 208(1) and a second client device 208(2) are illustrated as being in communication with VTAT device 202. In this regard, the first client device 208(1) and the second client device 208(2) may be “clients” of the VTAT device 202 and are described herein as such. Nevertheless, it is to be known and understood that the first client device 208(1) and/or the second client device 208(2) need not necessarily be “clients” of the VTAT device 202, or any entity described in association therewith herein. Any additional or alternative relationship may exist between either or both of first client device 208(1), second client device 208(2) and VTAT device 202, or no relationship may exist.

Further, VTAT device 202 is illustrated as being able to access external database(s) 206(1), and repository of virtual tethers 206(2). VTAT device 202 may comprise virtual tethering and authentication tool module 302, which communicates with external database(s) 206(1). In addition, virtual tethering and authentication tool module 302 of VTAT device 202 may also communicate with repository of virtual tethers 206(2). Virtual tethering and authentication tool module 302 may be configured to provide a dynamically customizable interface for virtually tethering a product to an authenticated physical record.

Moreover, VTAT device 202 may receive and transmit data via communication network(s) 210. VTAT device 202 may receive and transmit data such as code that is written in one or more of the following dialects: transaction control language (TCL), data manipulation language (DML), data control language (DCL) and data definition language (DFL). Additionally, via communication network(s) 210, VTAT device 202 may respectively receive and transmit data from and to one or more from among the following devices: server device 204, external database(s) 206(1), repository of virtual tethers 206(2) (or another database 206), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the VTAT device 202 via broadband or cellular communication. Of course, these embodiments are merely exemplary and are not limiting or exhaustive.

Virtual tethering and authentication tool module 302 provides a highly adaptable authentication framework that virtually tethers a product to an authenticated record. Moreover, virtual tethering and authentication tool module 302 improves the veracity, speed, accuracy, efficiency, and ease of use of existing product authentication technology.

Although virtual tethering and authentication tool module 302 may be preprogrammed with generic default virtual tethering and authentication settings, virtual tethering and authentication tool module 302 also provides the flexibility of virtual tethering and authentication settings that may be individually customized according to their specific requirements. Virtual tethering and authentication tool module 302 simplifies and accelerates authentication to save valuable time and resources while seamlessly virtually tethering products to respective authenticated records.

Virtual tethering and authentication tool module 302 may virtually tether products to respective authenticated records via one or more cloud-based databases. Moreover, virtual tethering and authentication tool module 302 may also incorporate robust error-handling, logging, and monitoring mechanisms for improved robustness and integrity when virtually tethering a product to an authenticated record.

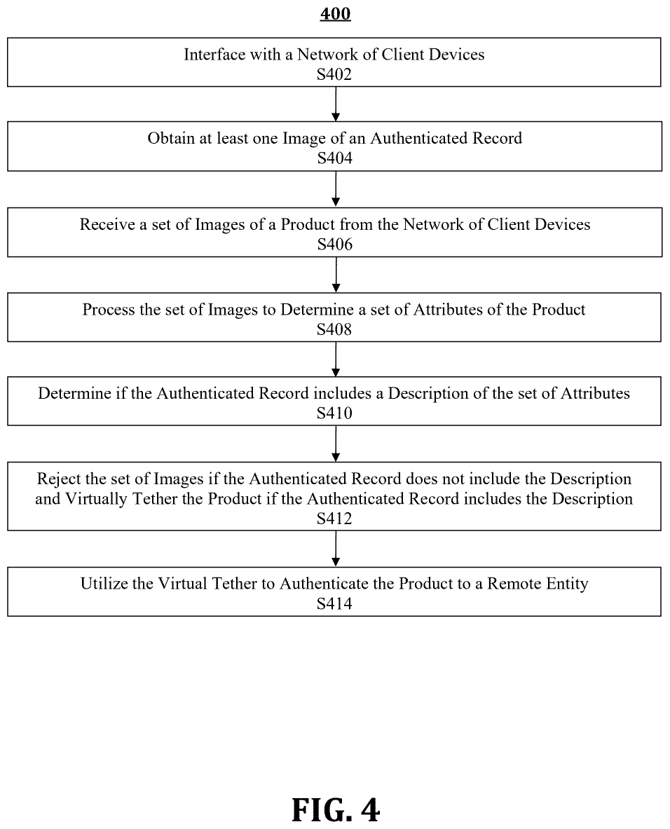

Virtual tethering and authentication tool module 302 may execute a process that virtually tethers a product to an authenticated physical record, thereby improving the veracity, speed, accuracy, efficiency, and ease of use of existing product authentication technology. An exemplary process for a virtual tethering and authentication tool is generally indicated at flowchart 400 in FIG. 4.

In process 400 of FIG. 4, at step S402, virtual tethering and authentication tool module 302 is interfaced with one or more networks of client devices, which includes a first network of client devices. In an embodiment, at step S402, virtual tethering and authentication tool module 302 may interface and/or be interfaced with the one or more networks of client devices (which includes the first network of client devices) via a physical and/or virtual (e.g., software) interface.

At step S404, virtual tethering and authentication tool module 302 obtains at least one image of an authenticated record. In an exemplary embodiment, virtual tethering and authentication tool module 302 may directly and/or indirectly obtain the at least one image from an authenticating entity that authenticated the authenticated record and, before and/or after step S404, virtual tethering and authentication tool module 302 may confirm an authenticity of the authenticated record with this entity.

In an embodiment, the at least one image of the authenticated record may be a genuine physical copy of the authenticated record such as, for example, one or more from among at least a title, certificate, deed, receipt, contract, bill of sale, etc. Although in process 400, step S402 is depicted as being performed prior to step S404, it should be noted that in further embodiments, virtual tethering and authentication tool module 302 may additionally (or alternatively) perform step S404 prior to step 402.

At step S406, virtual tethering and authentication tool module 302 receives a set of images of a product from the network of client devices. In an exemplary embodiment, the set of images may be received from a mobile client device such as at least one client device from among client devices 208(1)-208(n), for example. In a further embodiment, the set of images may have been captured by a camera of a user of the mobile client device. In yet a further embodiment, virtual tethering and authentication tool module 302 may analyze image attributes of the set of images to evaluate an authenticity of the set of images.

In an embodiment, the image attributes may comprise one or more from among a date, location, and format that respectively corresponds each image from among the set of images. In an additional or alternative embodiment, virtual tethering and authentication tool module 302 may verify the authenticity of the set of images by: (1) scanning the set of images and based on such scan, determining whether any image from among the set of images has been improperly altered; then (2) rejecting any images that have been improperly altered.

In an exemplary embodiment, an improperly altered image is an image that has been altered to misrepresent an identity of the product. In an embodiment, the rejection of any improperly altered images may further include removing (or eliminating) any such image(s) from the set of images before virtual tethering and authentication tool module 302 performs step S408.

Additionally (or alternatively), after step S406, virtual tethering and authentication tool module 302 may analyze image attributes of the set of images to ensure that each image from among the set of images includes a complete view of the product. In an embodiment, to ensure that each image from among the set of images includes a complete view of the product virtual tethering, authentication tool module 302 may: (1) determine based on the analysis for the complete view, whether any images from among the set of images does not include a complete view of the product; and (2) reject any images that does not include a complete view of the product. In a further embodiment, the rejection of any images that does not include the complete view of the product, may include removing (or eliminating) any such image(s) from among the set of images.

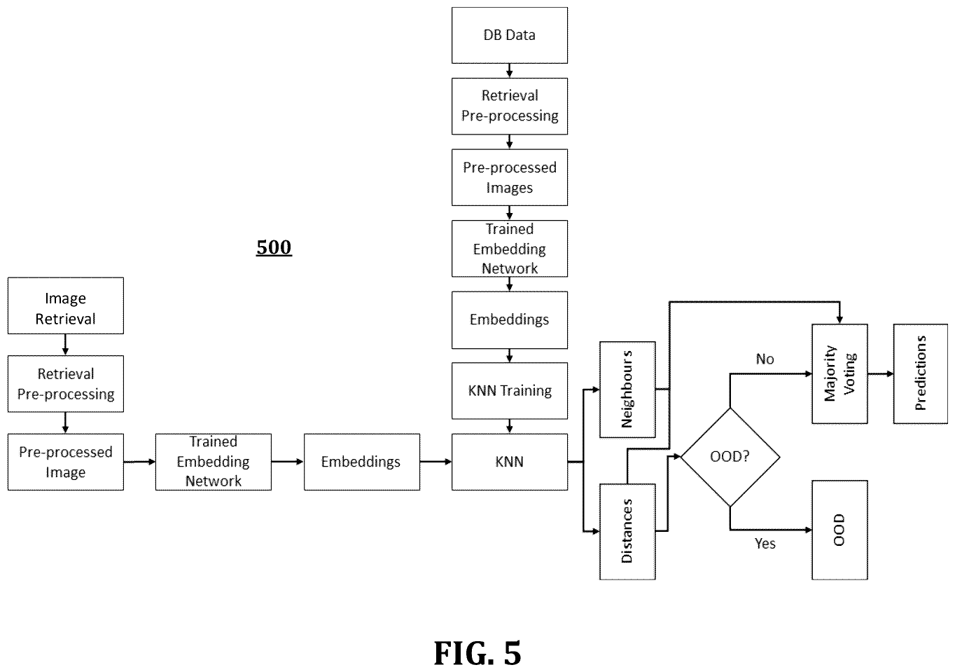

At step S408, virtual tethering and authentication tool module 302 processes the set of images to determine a set of attributes of the product. In an embodiment, the set of attributes of the product may comprise a set of features of the product. For example, at step S408, virtual tethering and authentication tool module 302 may process the set of images by performing a feature extraction feature on each image from among the set of images in order to transform the raw pixel values of each image from among the set of images into extracted features (e.g., attributes and corresponding values) that may be used by other image processing techniques such as point matching or an AI/ML image processing model that has been trained to search one or more databases for extracted features and to classify (or categorize) an image and/or thereby identify a product that is viewed in the image. In an exemplary embodiment, virtual tethering and authentication tool module 302 may utilize a distinct AI/ML image processing model to perform each of processes 500, 600 and 700, which are set forth below with respect to FIGS. 5-7.

At step S410, virtual tethering and authentication tool module 302 determines if the authenticated record includes a description of at least one from among the set of attributes and the set of features, e.g., color, model, manufacturer, year of manufacture. At step S412, virtual tethering and authentication tool module 302 rejects the set of images when it has been determined that the authenticated record does not include the description. However, when the it has been determined that the authenticated record does include the description, at step S412, virtual tethering and authentication tool module 302 virtually tethers the product to the authenticated record.

At step S414, virtual tethering and authentication tool module 302 utilizes the virtual tether to authenticate the product to a remote entity such as an organization, group, individual, software module, government agency, etc.

In an embodiment, virtual tethering and authentication tool module 302 may provide one or more indications of progress via an interface and, in a further embodiment, the interface may comprise a graphical user interface (GUI). In yet a further embodiment, an interface (such as a GUI) may be utilized by a user, administrator or some other entity (e.g., a software module) to perform each function mentioned above via virtual tethering and authentication tool module 302.

FIG. 5 depicts an exemplary flowchart of a process 500 that may be utilized by a virtual tethering and authentication tool to retrieve an image. In an embodiment, virtual tethering and authentication tool module 302 may utilize process 500 to identify features (or attributes) of a product's image that belong to classes (or categories) that cannot be found in a database such as external database(s) 206(1), for example.

Additionally, or alternatively, virtual tethering and authentication tool module 302 may utilize process 500 to identify (and classify) specific characteristics that make a product's image fall outside of a range of distribution of the images of products that are stored in memory that is accessible to virtual tethering and authentication tool module 302, such as a memory of virtual tethering and authentication tool module 302 or a database such as external database(s) 206(1), for example.

Virtual tethering and authentication tool module 302 may map similar datapoints of a view of a product close together in an embedding space (which may refer to a relatively low-dimensional space into which high-dimensional vectors may be translated) of the received image. Accordingly, in an embodiment, virtual tethering and authentication tool module 302 may utilize a first set of one or more artificial intelligence and machine learning (AI/ML) models that have been trained on large datasets (or big data) such as one or more Contrastive Language Image Pre-training (CLIP) and/or OpenCLIP datasets, to create high quality compressed representations of product images/views. In the embodiment, the large datasets (or big data) may comprise a large-scale dataset of images such as a Large-scale Artificial Intelligence Open Network (LAION) dataset such as, for example, LAION 2B which includes at least 2.2 billion text-image pairs.

Virtual tethering and authentication tool module 302 may utilize process 500 to address challenges such as an unavailability of a public dataset that includes all characteristics, features, or attributes of one or more products. To be specific, virtual tethering and authentication tool module 302 may address such unavailability by utilizing different datasets (such as Kaggle Vehicle Color Recognition Dataset and Stanford Car196 for vehicles) to cover all relevant characteristics of one or more products. Accordingly, in process 500, the retrieval of an image from database (DB) data may be divided into tasks comprising color retrieval and model retrieval.

In an exemplary embodiment, virtual tethering and authentication tool module 302 individually pre-processes each image after it is received. Accordingly, in the exemplary embodiment, when a set of images of a product is received (i.e., Image Retrieval) from a network of one or more client devices, virtual tethering and authentication tool module 302 will pre-process that set of images.

As depicted in FIG. 5, process 500 is initiated by the block labeled Image Retrieval, which represents the receipt of at least one image of a product (such as a vehicle) by a VTAT such as virtual tethering and authentication tool module 302. In response to this Image Retrieval, the VTAT may obtain database (DB) data as depicted by the block labeled DB Data. In an exemplary embodiment, the database (DB) may comprise one or more internal databases and/or it may comprise one or more external databases such as external database(s) 206(1), for example.

In process 500, after the set of images and the DB data are retrieved they are each respectively pre-processed as depicted by the blocks labeled Retrieval Pre-Processing. Thereby, one or more pre-processed images are generated by respectively pre-processing the set of images and the DB data as depicted by the blocks labeled Pre-processed Image and Pre-processed Image, respectively.

In process 500, the block labeled Trained Embedding Network represents one or more modules that have been trained to process the pre-processed images to create embeddings. These embeddings map images that belong to the same class (or category) close together within an embedding space while separating images from different classes apart from one another (with respect to their mappings) in the embedding space. Accordingly, as depicted in process 500, after the pre-processed images are generated, they are utilized by a Trained Embedding Network to convert each of the pre-processed images into a corresponding set of embeddings, respectively.

As depicted in process 500, after the pre-preprocessed images are each converted into their corresponding sets of embeddings, respectively, one or more different AI/ML models that have been trained to process sets of embeddings according to a K-nearest neighbor algorithm that determines the respective distances and neighbors of attributes such as extracted features of an image, for example. Based on the respective distances and neighbors of attributes, an out-of-distribution (OOD) algorithm (depicted by the decision diamond labeled OOD) determines whether a particular attribute falls outside of the range of distribution of a dataset (e.g., DB data).

As depicted in process 500, when attributes fall within a dataset's range of distribution, predictions are made about the classification (or categorization) of a received image of the Image Retrieval block. As depicted in process 500, the predictions that are made about the received image are made according to a majority voting system that is represented by the block labeled Majority Voting.

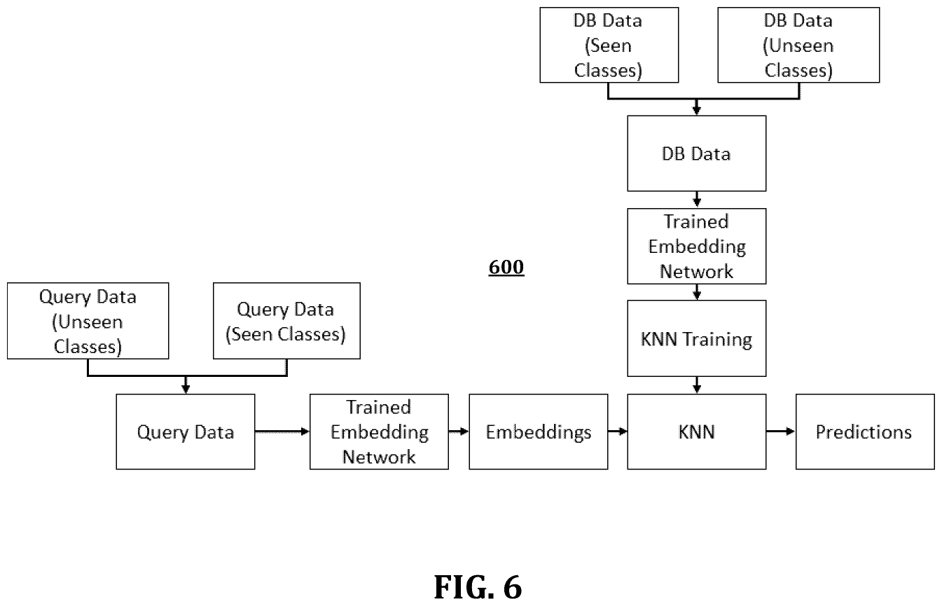

FIG. 6 depicts an exemplary flowchart of a process 600 that may be utilized by a virtual tethering and authentication tool to retrieve (and/or identify) one or more attributes (or characteristics) of an object depicted within an image. In an embodiment, the one or more attributes (or characteristics) may include an identifier of the object, such as a model (or product name). However, process 600 may additionally or alternatively be utilized to identify other attributes of the object, such as its color, for example. In an embodiment, virtual tethering and authentication tool module 302 may utilize process 600 to identify a product's characteristics of interest. In the embodiment, virtual tethering and authentication tool module 302 may utilize a second set of one or more AI/ML models that have been trained to retrieve (and/or identify) product characteristics that include a product type, model, color, manufacturer and year of manufacture. In an exemplary embodiment, the product may be a vehicle and its characteristics may include a type of vehicle for example, such as a sedan, a hatchback, an SUV, etc.

In an embodiment, virtual tethering and authentication tool module 302 may employ hierarchical metric learning, which is based on “hierarchical” relationships between various products (note: a product/product type has shared characteristics that are soft positives). The “hierarchy” structure includes classes (or categories) that are structured in the following manner: (1) Manufacturer+Model+Type+Year; (2) Manufacturer+Model+Type; (3) Manufacturer+Model; and (4) Manufacturer.

Additionally, in an embodiment, virtual tethering and authentication tool module 302 may employ a hierarchical mutli-similarity loss algorithm to train a network and/or at least one AI/ML model. Accordingly, such a hierarchical version of a multi-similarity loss algorithm may be based on or derived from inter alia the following equation:

$${L}_{MS} = \frac{1}{α} log [ 1 + {\sum }_{k ∈ P} {e}^{- α ( {S}_{k} - λ )} ] + \frac{1}{β} log [ 1 + {\sum }_{k ∈ N} {e}^{β ( {S}_{k} - λ )} ]$$

$${L}_{HMS} = \frac{1}{B} {\sum }_{i = 1}^{B} \frac{1}{L} {\sum }_{l = 1}^{L} {e}^{{l}^{- 1}} min ( {L}_{MS} ( {P}_{i , l} , {N}_{i , l} ) , {L}_{MS} ( {P}_{i , l - 1} , {N}_{i , l - 1} ) )$$

where S is a similarity measure between two embeddings in the batch, Pᵢ and Nᵢ are all positive and negative pairings with an anchor i, λ, α and β are fixed hyperparameters, L are all the “hierarchy” levels created for the dataset and B is the batch size.

An embodiment of the herein disclosed solution has been tested by utilizing a K-nearest neighbor algorithm on public dataset Cars196, which is a dataset of more than 16 thousand cars images that are categorized into 196 different classes (or categories including make, model and year). Slightly more than half of the Cars196 dataset's images are for the training of related AI/ML models, while the remaining images of that dataset are for the testing of such models.

The solution disclosed herein separates classes into an 80/20 of the following two sets: (1) classes included in a training set; and (2) classes that are not included in the training set(s), respectively. To measure a performance of this testing, the following two types of experiments were performed: (1) the testing a trained AI/ML model's ability to recognize one or more images that have been classified within an accessible dataset; and (2) testing a trained AI/ML model's ability to recognize one or more images that have been classified within an accessible dataset and one or more images that have not been classified within an accessible dataset.

Virtual tethering and authentication tool module 302 may map similar datapoints of a view of a product close together in an embedding space (which may refer to a relatively low-dimensional space into which high-dimensional vectors may be translated) of the received image. Accordingly, in an embodiment, virtual tethering and authentication tool module 302 may utilize one or more artificial intelligence and machine learning (AI/ML) models that have been trained on large datasets (or big data) such as CLIP and/or OpenCLIP, to create high quality compressed representations of product images/views. In the embodiment, the large datasets (or big data) may comprise a large-scale dataset of images such as a LAION dataset (e.g., LAION 2B includes at least 2.2 billion text-image pairs).

Virtual tethering and authentication tool module 302 may utilize process 600 to address challenges such as an unavailability of a public dataset that includes all characteristics, features, or attributes of one or more products. To be specific, virtual tethering and authentication tool module 302 may address such unavailability by utilizing different datasets (such as Kaggle Vehicle Color Recognition Dataset and Stanford Car196 for vehicles) to cover all relevant characteristics of one or more products. Accordingly, in process 600, the retrieval of an image from database (DB) data may be divided into tasks comprising color retrieval and model retrieval.

In an exemplary embodiment, virtual tethering and authentication tool module 302 may conduct one or more queries based on one or more sets of attributes of a received image of one or more views of a client's physical product, which may and/or may not be considered to be an asset to a client, user, user of the client or another entity.

As depicted in FIG. 6, process 600 is initiated by either of the blocks labeled Query Data (Unseen Classes) and Query Data (Seen Classes), which respectively represents one or more queries based on one or more sets of attributes of a received image of one or more views of a client's physical product. In response to this Query Data, a VTAT may obtain database (DB) data as depicted by the block labeled DB Data. As depicted, the DB Data may be obtained from either seen classes or unseen classes, which thereby permit process 600 to retrieve (or identify) new objects that have not yet been classified (or categorized). In an exemplary embodiment, the database (DB) may comprise one or more internal databases and/or it may comprise one or more external databases such as external database(s) 206(1), for example.

In process 600, after it is obtained, the Query Data is processed by a Trained Embedding Network, which converts the Query Data's one or more sets of attributes into corresponding sets of embeddings. Similarly, after the DB Data is obtained, it is processed by the Trained Embedding Network to convert the DB data's one or more sets of attributes into corresponding sets of embeddings. Subsequently, the sets of embeddings extracted from the DB data are used to train one or more AI/ML models to process one or more sets of attributes (e.g., of an image) based on a K-nearest neighbor algorithm, which is then utilized to generate a model retrieval score of the similarity of the obtained DB Data by processing the Query Data's embeddings, and the model retrieval score is then used to make predictions.

In a further embodiment, during process 600, DB Data that is retrieved (or obtained) may comprise a model that is associated with a most favorable score (e.g., highest) from among one or more sets of scores associated with models that are available to a VTAT during process 600. Thereby, one or more views of a client's physical product may be identified as the model with the most favorable score.

As mentioned above, FIG. 6 depicts an exemplary flowchart of a process 600 that may be utilized by a virtual tethering and authentication tool to retrieve (and/or identify) one or more colors of a product. In an embodiment, virtual tethering and authentication tool module 302 may utilize process 600 to identify one or more colors of a product. In the embodiment, virtual tethering and authentication tool module 302 may utilize a third set of one or more AI/ML models that have been trained to retrieve (and/or identify) one or more product colors.

In an exemplary embodiment, a virtual tethering and authentication tool may utilize Kaggle Vehicle Color Recognition (VCoR) dataset, which is a training dataset that may be used to train one or more AI/ML models to recognize one or more colors of a vehicle. Additionally (or alternatively), in a further embodiment, a multi-similarity loss function may have been utilized to train such a color recognition AI/ML model.

As depicted in FIG. 6, process 600 is initiated by either of the blocks labeled Query Data (Unseen Classes) and Query Data (Seen Classes), which represents one or more queries based on one or more sets of attributes of a received image of one or more views of a client's physical product, which may further include an authenticatable identification (such as a license plate, for example). In response to this Query Data, a VTAT may obtain database (DB) data as depicted by the block labeled DB Data. In an exemplary embodiment, the database (DB) may comprise one or more internal databases and/or it may comprise one or more external databases such as external database(s) 206(1), for example.

In process 600, after it is obtained, the Query Data is processed by a Trained Embedding Network, which converts the Query Data's one or more sets of attributes into corresponding sets of embeddings. Similarly, after the DB Data is obtained, it is utilized by a Trained Embedding Network to train one or more AI/ML models that are trained to process one or more sets of attributes (e.g., of an image) based on a K-nearest neighbor algorithm, which is then utilized to generate a color retrieval score for a similarity of the obtained DB Data by processing the Query Data's embeddings, and the color retrieval score is then used to make predictions depicted in FIG. 6.

In a further embodiment, during process 600, DB Data that is retrieved (or obtained) may comprise one or more colors that are associated with one or more most favorable scores (such as the highest one, two, three or four scores, for example) from among one or more sets of scores associated with colors that are available to a VTAT during process 600. Thereby, one or more views of a client's physical product may be identified as being comprised of the one or more colors that are associated with the one or more most favorable scores.

In yet a further embodiment, a virtual tethering and authentication tool may comprise a component (that includes a scanner and/or an optical character recognition (OCR) feature) that retrieves (or identifies) an authenticatable identification, which may comprise one or more from among barcodes, quick-response codes (QR codes), numbers, letters, and other characters and symbols (such as ASCII characters, for example).

In an exemplary embodiment, a custom dataset was built to generate artificial images of authenticatable “license plate” identifications. In the exemplary embodiment, the artificial images comprise artificial imperfection such as random blur, resolution reduction, tilt, and shadow placement, for example. In a further embodiment, one hundred thousand artificial images of license plates were utilized to fine-tune a transformer OCR (TrOCR) model, and an open source AI/ML image-based object detection model (e.g., YOLOv5) may be utilized to detect license plates.

In the exemplary embodiment, license plate detection may be based on a probabilistic model which evaluates the probability that a region of an image includes a license plate. In a further embodiment, an evaluation (or analysis) of an accuracy of such a license plate detection model may be based on a metric, such as a dice score (DS), which evaluates the similarity between two bounding boxes. In addition, or alternatively, a license plate detection model's accuracy may also be based on an intersection over union (IoU), which measures overlap between predicted and ground truth bounding boxes. In this embodiment, both the DS and IoU elements may be scores that have a value between the values of 0 and 1 (the higher the better). To be specific, this embodiment's DS, IoU and character error rate (CER) elements may be determined according to the following algorithms:

$$DS = \frac{2 * \vert A ⋂ B \vert}{\vert A \vert + \vert B \vert}$$

$$IoU = \frac{\vert A ⋂ B \vert}{\vert A ⋃ B \vert}$$

$$CER = \frac{S + D + I}{N}$$

In the above exemplary embodiment, the CER represents a proportion of characters in a ground truth text that were incorrectly predicted/determined. In the embodiment, the CER may be based upon a Levenshtein distance where S, D, and I correspond to a number of substitutions, deletions, and insertions needed to transform a ground truth text into a predicted (or determined) text respectively. This embodiment's CER element may be a score that has a value between the values of 0 and 1 (where lower is better).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for implementing a tool that virtually tethers a product to an authenticated physical record of the product, the method comprising:
receiving a set of images of a first product, wherein the set of images comprises at least one complete view of the first product, wherein the first product occupies a majority of a visible region of the at least one complete view, and wherein at least one view from among the at least one complete view further captures an authenticatable identification of the first product;
processing the set of images to determine a first set of attributes of the first product;
determining whether the authenticated physical record comprises a description of the first set of attributes; and
when a determination is made that the authenticated physical record comprises the description of the first set of attributes, utilizing the tool to virtually tether the first product to the authenticated physical record.

2. The method of claim 1, wherein the first set of attributes comprises at least one from among: a first product type, a first product color, a first product model, a first product manufacturer, and a first product year of manufacture.

3. The method of claim 1, wherein the first product comprises: a vehicle and wherein the authenticatable identification comprises a license plate.

4. The method of claim 1, wherein the processing comprises: determining a predetermined number of product features that fall within a similarity threshold of at least one feature of the first product by comparing the first set of images to a reference data repository of the product features.

5. The method of claim 1, wherein the processing comprises: determining a first product color and a first product model.

6. The method of claim 5, wherein the determining the first product color and the first product model comprises: utilizing, to perform the processing, an artificial intelligence and machine learning (AI/ML) model that evaluates the set of images.

7. The method of claim 6, wherein the AI/ML model comprises: a first AI/ML model that is trained to determine the first product color and a second AI/ML model that is trained to determine the first product model.

8. The method of claim 1, further comprising: when at least one incomplete view of the first product is received, rejecting the at least one incomplete view.

9. The method of claim 1, further comprising: generating the at least one complete view by cropping a second image, wherein the first product occupies less than a majority of the visible region of the second image.

10. The method of claim 1, wherein each image included in the set of images is captured by at least one camera.

11. A system for implementing a tool that virtually tethers a product to an authenticated physical record of the product, the system comprising:
a processor; and
memory storing instructions that, when executed by the processor, cause the processor to perform operations including:
receiving a set of images of a first product, wherein the set of images comprises at least one complete view of the first product, wherein the first product occupies a majority of a visible region of the at least one complete view, and wherein at least one view from among the at least one complete view further captures an authenticatable identification of the first product;
processing the set of images to determine a first set of attributes of the first product;
determining whether the authenticated physical record comprises a description of the first set of attributes; and
when a determination is made that the authenticated physical record comprises the description of the first set of attributes, utilizing the tool to virtually tether the first product to the authenticated physical record.

12. The system of claim 11, wherein when executed by the processor, the instructions cause the processing to comprise: determining a predetermined number of product features that fall within a similarity threshold of at least one feature of the first product by comparing the first set of images to a reference data repository of the product features.

13. The system of claim 11, wherein when executed by the processor, the instructions cause the processing to comprise: determining a first product color and a first product model.

14. The system of claim 13, wherein when executed by the processor, the instructions cause the determining the first product color and the first product model to comprise:
utilizing, to perform the processing, an artificial intelligence and machine learning (AI/ML) model that evaluates the set of images.

15. The system of claim 14, wherein when executed by the processor, the instructions cause the AI/ML model to comprise: a first AI/ML model that is trained to determine the first product color and a second AI/ML model that is trained to determine the first product model.

16. The system of claim 11, wherein when executed, the instructions cause the processor to perform further operations including:
when at least one incomplete view of the first product is received, rejecting the at least one incomplete view.

17. The system of claim 11, wherein when executed, the instructions cause the processor to perform further operations including:
generating the at least one complete view by cropping a second image, wherein the first product occupies less than a majority of the visible region of the second image.

18. A non-transitory computer-readable medium for implementing a tool that virtually tethers a product to an authenticated physical record of the product, the computer-readable medium storing instructions that, when executed by a processor, cause the processor to perform operations including:
receiving a set of images of a first product, wherein the set of images comprises at least one complete view of the first product, wherein the first product occupies a majority of a visible region of the at least one complete view, and wherein at least one view from among the at least one complete view further captures an authenticatable identification of the first product;
processing the set of images to determine a first set of attributes of the first product;
determining whether the authenticated physical record comprises a description of the first set of attributes; and
when a determination is made that the authenticated physical record comprises the description of the first set of attributes, utilizing the tool to virtually tether the first product to the authenticated physical record.

19. The computer-readable medium of claim 18, wherein when executed by the processor, the instructions cause the processing to comprise: determining a predetermined number of product features that fall within a similarity threshold of at least one feature of the first product by comparing the first set of images to a reference data repository of the product features.

20. The computer-readable medium of claim 18, wherein when executed by the processor, the instructions cause the processing to comprise:
utilizing, to determine the first set of attributes, an artificial intelligence and machine learning (AI/ML) model that is trained to determine the first product color and a second AI/ML model that is trained to determine the first product model.
